(19) United States
(12) Patent Application Publication
(10) Pub. No.: US 2025/0122377 A1
(43) Pub. Date: Apr. 17, 2025

(54) Thermoplastic Polymer Composition Having Enhanced Sag Resistance

(71) Applicant: Celanese Polymers Holding, Inc., Wilmington, DE (US)

(72) Inventor: Shailesh Ratilal Doshi, Kingston (CA)

(21) Appl. No.: 18/912,988

(22) Filed: Oct. 11, 2024

Related U.S. Application Data
(60) Provisional application No. 63/590,010, filed on Oct. 13, 2023.

(51) Int. Cl. C08L 77/02

(52) U.S. Cl. CPC C08L 77/02; C08L 2203/30; C08L 2205/025; C08L 2205/035

(57) ABSTRACT

The present disclosure is generally directed to a thermoplastic polymer composition. The thermoplastic polymer composition may be particularly applicable in blow molding applications. The thermoplastic polymer composition may include a first polyamide, a second polyamide, and a third polyamide.

### RELATED APPLICATIONS

The present application is based upon and claims priority to U.S. Provisional Patent Application Ser. No. 63/590,010, having a filing date of Oct. 13, 2023, which is incorporated herein by reference in its entirety.

### BACKGROUND

In recent years, corporate sustainability initiatives and national environmental initiatives have become increasingly prominent and influential. For instance, electric vehicles have become increasingly prominent as consumers and various industries attempt to reduce carbon emissions. Notably, fuel cell vehicles, which are a type of electric vehicle, include fuel cells that generate electricity by reacting hydrogen gas with oxygen gas. Generally, a tank containing hydrogen gas is utilized to store the hydrogen gas in a fuel cell vehicle. A significant consideration in manufacturing a tank suitable for containing hydrogen gas is the gas permeability of the tank. Indeed, the small molecular size of hydrogen makes hydrogen particularly difficult to retain in a container, such as a tank. Consequently, hydrogen gas tanks generally include a polymeric liner, which is utilized to prevent or reduce the permeation of the hydrogen gas outside of the tank. Further, hydrogen internal combustion engines may utilize a polymeric liner in one or more components thereof.

Generally, polymeric liners utilized in gas tanks may be formed by injection molding, extrusion molding, or blow molding. Both injection molding and extrusion molding processes may require making the polymeric liner in two or more sections, which are generally welded together in a secondary step. Notably, the blow molding process is capable of forming a complete polymeric liner as a single monolithic piece and thus may not utilize subsequent welding steps. As such, blow molding may be a generally preferable method for large size liners. Notably, blow molding is a demanding process that preferably utilizes a polymeric material that has good melt sag resistance and melt solidification characteristics suitable to form a reliable pinch-weld during the molding cycle. Further, traditional polymeric liners that undergo formation via blow molding may have limited sag resistance, may have sharp freezing points, and may have limited cold impact resistance or toughness.

Consequently, a need currently exists for a thermoplastic polymer composition that is suitable as a polymeric liner for tanks, particularly hydrogen tanks utilized in fuel cell vehicles.

### SUMMARY

In general, the present disclosure is directed to a thermoplastic polymer composition. The thermoplastic polymer composition may be particularly suitable in blow molding applications.

In one aspect, the thermoplastic polymer composition may comprise a first polyamide, the first polyamide comprising a first aliphatic homopolyamide; a second polyamide, the second polyamide comprising a semi-aromatic copolyamide; a third polyamide, the third polyamide comprising a second aliphatic homopolyamide, wherein the first aliphatic homopolyamide and the second aliphatic homopolyamide may be present in the thermoplastic polymer composition in a weight ratio of about 5:4 or more; and an impact modifier, the impact modifier is present in the thermoplastic polymer composition in an amount greater than about 5 wt. %.

In one aspect, the first aliphatic homopolyamide may comprise repeat units derived from a lactam having 6 to 20 carbon atoms. In one aspect, the second aliphatic homopolyamide may comprise repeat units derived from an aliphatic dicarboxylic acid having 6 to 20 carbon atoms and an aliphatic diamine having 4 to 20 carbon atoms.

In one aspect, the semi-aromatic copolyamide may comprise repeat units derived from an aromatic dicarboxylic acid having 8 to 20 carbon atoms and an aliphatic diamine having 4 to 20 carbon atoms. The semi-aromatic copolyamide may further comprise repeat units derived from an aliphatic dicarboxylic acid having 6 to 20 carbon atoms and an aliphatic diamine having 4 to 20 carbon atoms. Notably, the semi-aromatic copolyamide may comprise a first repeat unit present in an amount from about 50 mole percent to about 90 mole percent and a second repeat unit present in an amount from about 10 mole percent to about 50 mole percent of the semi-aromatic copolyamide.

In one aspect, the first repeat unit may be an aliphatic repeat unit and the second repeat unit may be an aromatic repeat unit.

In one aspect, the semi-aromatic copolyamide may comprise a first repeat unit present in an amount from about 60 mole percent to about 80 mole percent and a second repeat unit present in an amount from about 20 mole percent to about 40 mole percent of the semi-aromatic copolyamide. In one aspect, the first repeat unit may be an aliphatic repeat unit and the second repeat unit may be an aromatic repeat unit.

In one aspect, the aliphatic repeat units of the semi-aromatic copolyamide are substantially identical to the repeat units of one of the aliphatic homopolyamides.

In general, the first aliphatic homopolyamide and the second aliphatic homopolyamide may be present in the thermoplastic polymer composition in a weight ratio of about 3:2 or more.

In one aspect, the impact modifier may be functionalized. In one aspect, the impact modifier may comprise an anhydride group. The impact modifier may be present in the thermoplastic polymer composition in an amount less than about 50 wt. %.

In general, the first aliphatic homopolyamide may be present in the thermoplastic polymer composition in an amount from about 20 wt. % to about 70 wt. %. Further, the second aliphatic homopolyamide may be present in the thermoplastic polymer composition in an amount from about 2 wt. % to about 20 wt. %. Additionally, the semi-aromatic copolyamide may be present in the thermoplastic polymer composition in an amount from about 2 wt. % to about 30 wt. %.

In another aspect, a thermoplastic polymer composition may comprise a first polyamide, the first polyamide comprising an aliphatic copolyamide; a second polyamide, the second polyamide comprising a semi-aromatic copolyamide; a third polyamide, the third polyamide comprising an aliphatic homopolyamide, wherein the aliphatic copolyamide and the semi-aromatic copolyamide may be present in the thermoplastic polymer composition in a weight ratio of about 6:5 or more; and an impact modifier, the impact modifier being present in the thermoplastic polymer composition in an amount greater than about 5 wt. %.

Notably, the aliphatic copolyamide may comprise repeat units derived from an aliphatic dicarboxylic acid having 6 to 20 carbon atoms and an aliphatic diamine having 4 to 20 carbon atoms. The aliphatic copolyamide may further comprise repeat units derived from a lactam having 6 to 20 carbon atoms.

In one aspect, the semi-aromatic copolyamide may comprise repeat units derived from an aromatic dicarboxylic acid having 8 to 20 carbon atoms and an aliphatic diamine having 4 to 20 carbon atoms. Further, the semi-aromatic copolyamide may further comprise repeat units derived from an aliphatic dicarboxylic acid having 6 to 20 carbon atoms and an aliphatic diamine having 4 to 20 carbon atoms.

In general, the aliphatic homopolyamide may comprise repeat units derived from an aliphatic dicarboxylic acid having 6 to 20 carbon atoms and an aliphatic diamine having 4 to 20 carbon atoms. In one aspect, aliphatic repeat units of the semi-aromatic copolyamide are substantially identical to the repeat units of the aliphatic homopolyamide.

### BRIEF DESCRIPTION OF THE DRAWINGS

A full and enabling disclosure of the present disclosure is set forth more particularly in the remainder of the specification, including reference to the accompanying figure, in which:

FIG. 1 illustrates a cross-sectional view of one embodiment of a tank lined with a thermoplastic polymer composition in accordance with the present disclosure;

FIG. 2 illustrates a perspective view of one embodiment of a sag resistance test system in accordance with the present disclosure; and

FIG. 3 illustrates a graphical representation of the sag resistance of one embodiment of a thermoplastic polymer composition in accordance with the present disclosure and a comparative composition.

Repeat use of reference characters in the present specification and drawings is intended to represent the same or analogous features or elements of the present invention.

### DETAILED DESCRIPTION

Reference will now be made in detail to various embodiments of the disclosed subject matter, one or more examples of which are set forth below. Each embodiment is provided by way of explanation of the subject matter, not limitation thereof. In fact, it will be apparent to those skilled in the art that various modifications and variations may be made in the present disclosure without departing from the scope or spirit of the subject matter. For instance, features illustrated or described as part of one embodiment, may be used in another embodiment to yield a still further embodiment.

In general, the present disclosure is directed to a thermoplastic polymer composition and related methods. The thermoplastic polymer composition may include one or more polyamides, such as three polyamides. For instance, a thermoplastic polymer composition may include one or more semi-aromatic copolyamides, one or more aliphatic copolyamides, and/or one or more aliphatic homopolyamides. Additionally, one or more polyamides may be crystalline or semi-crystalline. Notably, the utilization of three polyamides in the thermoplastic polymer composition may be particularly beneficial as opposed to the utilization of two polyamides. The thermoplastic polymer composition may be particularly suitable for blow molding applications. Notably, the thermoplastic polymer composition may have enhanced sag resistance, reduced gas permeability, enhanced cold impact resistance or toughness, enhanced high temperature rigidity, and/or may allow for increased molding time and pinch-weld development time during the blow molding production step.

It should be understood that throughout the entirety of this specification, each numerical value (e.g., weight percentage) disclosed should be read as modified by the term “about” (unless already expressly so modified) and then read again as not to be so modified. For instance, a value of “100” is to be understood as disclosing “100” and “about 100”. Further, it should be understood that throughout the entirety of this specification, when a numerical range (e.g., weight percentage) is described, any and every amount of the range, including the endpoints and all amounts therebetween, is disclosed. For instance, a range of “1 to 100”, is to be understood as disclosing both a range of “1 to 100 including all amounts therebetween” and a range of “about 1 to about 100 including all amounts therebetween”. The amounts therebetween may be separated by any incremental value. It should be understood that, unless stated otherwise, any standard listed herein (e.g., ASTM) is the most recent version available as of the latest revision year. Notably, some aspects of the present disclosure may omit one or more of the features disclosed herein.

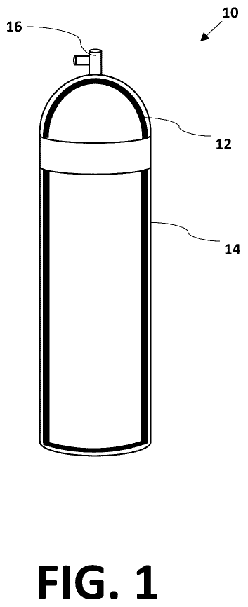

Notably, a thermoplastic polymer composition made in accordance with the present disclosure may be formed into a tubular member, such as a tank liner. For instance, FIG. 1 illustrates one embodiment of a tank liner 12 of a gas tank 10. In FIG. 1, the gas tank 10 includes an outer shell 14, which may be formed from a fiber reinforced plastic or a metal. Further, the gas tank 10 of FIG. 1 includes a tank valve 16. One process by which the thermoplastic polymer composition may be formed into a tubular member is by blow molding, which is particularly useful for making large hollow items such as bottles, drums, and tanks from thermoplastic materials. During blow molding, the thermoplastic polymer composition may first be heated and extruded using a die attached to an extrusion device. The extruded molten tubular member is suspended from the die, and is referred to as a “parison”. Next, the parison may be received into a molding device, that may be formed from one or more sections that form a three-dimensional mold cavity. In some aspects, a robotic arm may be utilized to manipulate the parison in the molding device. The molding device may be closed and may enclose the parison. The parison may then be sealed at its open end by bringing its opposing inner molten surfaces together and forming a pinch by the mold walls. A pinch formed in this manner may develop a weld resulting in a leak-proof seal during the subsequent forming and solidification steps. This weld may be referred to as a “pinch-weld”.

Once the molding device is closed, a gas (e.g., air, nitrogen, an inert gas) is fed into the parison from a gas supply. The gas supplies sufficient pressure against the interior surface of the parison such that the parison conforms to the shape of the mold cavity. After the solidification of the blow molded article (e.g., blow molded thermoplastic polymer composition), the sections of the molding device may be opened or withdrawn, and the finished shaped article (e.g., tank liner) may then be removed. In one aspect, cool air may be injected into the molded part (e.g., tank liner) to solidify the thermoplastic polymer composition prior to removal from the molding device.

Notably, during and after parison formation, the parison is generally suspended for a period of time after exiting the extrusion device. In this respect, a certain period of time elapses from the formation of the parison, moving the parison into engagement with the molding device, closing of the mold and pinching of the parison end, blowing of the parison to conform to the mold cavity and solidification. During these stages of the process, the melt strength of the thermoplastic polymer composition is preferably high enough such that the parison maintains its tubular shape generally without collapsing or excessively thinning out along its length. Indeed, when the parison is formed, the thermoplastic polymer composition must have sufficient melt strength to prevent gravity from undesirably elongating portions (i.e., sag) of the parison and thereby forming non-uniform wall thicknesses and other imperfections. In this respect, it is preferable that the parison does not flow or deform significantly before the molding step. An additional consideration is that the thermoplastic polymer composition is preferably capable of remaining in a semi-fluid state and not solidifying too rapidly before the blowing step commences so that the parison is able to conform to the details of the molding device. To facilitate the formation of a strong pinch weld, it is also desirable that the thermoplastic polymer composition does not have a sharp freezing point, but rather solidifies over a broader range of temperatures.

In general, the thermoplastic polymer composition may include one or more polyamides. For instance, the thermoplastic polymer composition may include a first polyamide, a second polyamide, and a third polyamide. In general, the first polyamide, the second polyamide, and/or the third polyamide may comprise one or more homopolymers and/or one or more copolymers, including any of the homopolymers and/or copolymers disclosed herein. For instance, in one aspect, the thermoplastic polymer composition may include a first polyamide, the first polyamide comprising a first aliphatic homopolyamide; a second polyamide, the second polyamide comprising a semi-aromatic copolyamide; and a third polyamide, the third polyamide comprising a second aliphatic homopolyamide. In another aspect, the thermoplastic polymer composition may include a first polyamide, the first polyamide comprising an aliphatic copolyamide; a second polyamide, the second polyamide comprising a semi-aromatic copolyamide; and a third polyamide, the third polyamide comprising an aliphatic homopolyamide.

Notably, the utilization of two or more polyamides having at least some of their repeat units being the same, that is, derived from the same diacid (e.g., aliphatic dicarboxylic acid) and the same diamine (e.g., aliphatic diamine), in a thermoplastic polymer composition formed in accordance with the present disclosure may have enhanced compatibility as opposed to two or more polyamides having different repeat units. For instance, in one aspect, a thermoplastic polymer composition formed in accordance with the present disclosure may contain a semi-aromatic copolyamide and an aliphatic homopolyamide that have the same aliphatic repeat units.

In some aspects, the thermoplastic polymer composition may include the first polyamide in an amount from about 20 wt. % to about 70 wt. %, including all increments of 1 wt. % therebetween, such as about 20 wt. % or more, such as about 30 wt. % or more, such as about 35 wt. % or more, such as about 40 wt. % or more, such as about 45 wt. % or more, such as about 50 wt. % or more, such as about 55 wt. % or more, such as about 60 wt. % or more, such as about 70 wt. % or less, such as about 60 wt. % or less, such as about 55 wt. % or less, such as about 50 wt. % or less, such as about 45 wt. % or less, such as about 40 wt. % or less, such as about 35 wt. % or less, such as about 30 wt. % or less.

In some aspects, the thermoplastic polymer composition may include the second polyamide in an amount from about 2 wt. % to about 30 wt. %, including all increments of 1 wt. % therebetween, such as about 2 wt. % or more, such as about 5 wt. % or more, such as about 10 wt. % or more, such as about 15 wt. % or more, such as about 20 wt. % or more, such as about 25 wt. % or more, such as about 30 wt. % or less, such as about 25 wt. % or less, such as about 20 wt. % or less, such as about 15 wt. % or less, such as about 10 wt. % or less, such as about 5 wt. % or less.

In some aspects, the thermoplastic polymer composition may include the third polyamide in an amount from about 2 wt. % to about 20 wt. %, including all increments of 1 wt. % therebetween, such as about 2 wt. % or more, such as about 5 wt. % or more, such as about 10 wt. % or more, such as about 15 wt. % or more, such as about 20 wt. % or less, such as about 15 wt. % or less, such as about 10 wt. % or less, such as about 5 wt. % or less.

In general, the thermoplastic polymer composition and/or a polyamide thereof (e.g., a first polyamide, a second polyamide, a third polyamide), may include one or more aliphatic homopolyamides, such as a first aliphatic homopolyamide and a second aliphatic homopolyamide. Notably, the first aliphatic homopolyamide and the second aliphatic homopolyamide may be present in the thermoplastic polymer composition in a weight ratio of about 5:4 or more, such as about 3:2 or more, such as about 2:1 or more, such as about 3:1 or more, such as about 4:1 or more, such as about 5:1 or more, such as about 6:1 or more, such as about 8:1 or more, such as about 10:1 or more, such as about 12:1 or less, such as about 10:1 or less, such as about 8:1 or less, such as about 6:1 or less, such as about 5:1 or less, such as about 4:1 or less, such as about 3:1 or less, such as about 2:1 or less, such as about 3:2 or less.

In general, the thermoplastic polymer composition and/or a polyamide thereof (e.g., a first polyamide, a second polyamide, a third polyamide), may include one or more aliphatic copolyamides and/or one or more semi-aromatic copolyamides. Notably, an aliphatic copolyamide and a semi-aromatic copolyamide may be present in the thermoplastic polymer composition in a weight ratio of about 6:5 or more, such as about 5:4 or more, such as about 3:2 or more, such as about 2:1 or more, such as about 3:1 or more, such as about 4:1 or more, such as about 5:1 or more, such as about 6:1 or more, such as about 8:1 or more, such as about 10:1 or more, such as about 12:1 or less, such as about 10:1 or less, such as about 8:1 or less, such as about 6:1 or less, such as about 5:1 or less, such as about 4:1 or less, such as about 3:1 or less, such as about 2:1 or less, such as about 3:2 or less, such as about 5:4 or less.

Notably, the polyamides disclosed herein may be homopolymers and/or copolymers. The homopolymers and copolymers are identified by their respective repeat units. The following list exemplifies the abbreviations used to identify monomers and repeat units in the homopolymer polyamides and the copolymer polyamides:

TABLE 1

| Abbreviation | Description |
|---|---|
| HMD | hexamethylene diamine (or 6 when used in |
| | combination with a diacid) |
| T | Terephthalic acid |
| AA | Adipic acid |
| DMD | Decamethylenediamine |
| DDA | Decanedioic acid |
| DDDA | Dodecanedioic acid |
| I | Isophthalic acid |
| MXD | meta-xylylene diamine |
| 2-MPMD | 2-methylpentamethylenediamine |
| TMD | 1,4-tetramethylene diamine |
| 4T | polymer repeat unit formed from TMD and T |
| 6T | polymer repeat unit formed from HMD and T |
| DT | polymer repeat unit formed from 2-MPMD and T |
| MXD6 | polymer repeat unit formed from MXD and AA |
| 66 | polymer repeat unit formed from HMD and AA |
| 10T | polymer repeat unit formed from DMD and T |
| 410 | polymer repeat unit formed from TMD and DDA |
| 510 | polymer repeat unit formed from 1,5- |
| | pentanediamine and DDA |
| 610 | polymer repeat unit formed from HMD and DDA |
| 612 | polymer repeat unit formed from HMD and DDDA |
| 6 | polymer repeat unit formed from |
| | ^{€}-caprolactam |
| 11 | polymer repeat unit formed from 11- |
| | aminoundecanoic acid |
| 12 | polymer repeat unit formed from 12- |
| | aminododecanoic acid |

Notably, as previously disclosed herein, the aforementioned list (i.e., Table 1) exemplifies the abbreviations used to identify monomers and repeat units in the homopolyamides and the copolyamides. In this respect, one or more homopolyamides and/or one or more copolyamides, such as one or more homopolyamides and/or one or more copolyamides of the first polyamide, the second polyamide, and/or the third polyamide, of a thermoplastic polymer composition may comprise or be formed from HMD, T, AA, DMD, 6, DDA, DDDA, I, MXD, 2-MPMD, TMD, 4T, 6T, DT, MXD6, 66, 10T, 410, 510, 610, 612, 6, 11, 12, or a combination thereof.

With respect to Table 1, and more generally the entirety of this disclosure, it should be understood that the term “6”, when used alone, designates a polymer repeat unit formed from €-caprolactam. Alternatively, “6” when used in combination with a diacid such as T, for instance 6T, the “6” refers to HMD. In repeat units comprising a diamine and diacid, the diamine is designated first. Furthermore, when “6” is used in combination with a diamine, for instance 66, the first “6” refers to the diamine HMD, and the second “6” refers to adipic acid. Likewise, repeat units derived from other amino acids or lactams are designated as single numbers designating the number of carbon atoms.

Generally, copolyamide repeat units are separated by one or more forward slashes (i.e.,/). For instance, poly(decamethylene decanediamide/decamethylene terephthalamide) is abbreviated PA1010/10T (75/25), with the values in brackets being the mole % repeat unit of each repeat unit in the copolyamide. In general, the repeat unit present in the higher proportion is indicated first followed by the repeat unit present in the lower proportion. Notably, if a range is disclosed with respect to the mole % repeat unit of a repeat unit in the copolyamide, it should be understood that the range encompasses all numbers between the two respective values occupying their respective position in the copolyamide or terpolyamide description. For instance, PA 612/6T (85/15) to (55/45) would include all numbers before the forward slash at or between 85 and 55 and would include all numbers after the forward slash at or between 15 and 45. In this respect, PA 612/6T (85/15) to (55/45) may include, for instance, PA 612/6T (75/25), PA 612/6T (70/30), or PA 612/6T (60/40). Further, if a copolyamide has three repeat units (e.g., a terpolyamide) the range would include all numbers at and between the two numbers before the first forward slash, all numbers at and between the two numbers after the first forward slash, and all numbers at and between the two numbers after the second forward slash. As used herein, the value before the forward slash may be referred to as the first repeat unit, and the value after the forward slash may be referred to as the second repeat unit. When a terpolyamide is used, the value after the second forward slash may be referred to as a third repeat unit. Notably, the first repeat, second repeat unit, and/or third repeat unit may refer to an aliphatic repeat unit or an aromatic repeat unit.

In general, one or more copolyamides (e.g., a semi-aromatic copolyamide, an aliphatic copolyamide) may have a mole % repeat unit of the first repeat unit in an amount from about 50 to about 90, including all increments of 1 mole % therebetween. For instance, one or more copolyamides may have a mole % repeat unit of the first repeat unit in an amount of about 50% or more, such as about 55% or more, such as about 60% or more, such as about 65% or more, such as about 70% or more, such as about 75% or more, such as about 80% or more, such as about 85% or more, such as about 90% or less, such as about 85% or less, such as about 80% or less, such as about 75% or less, such as about 70% or less, such as about 65% or less, such as about 60% or less, such as about 55% or less. Notably, for a semi-aromatic copolyamide, the first repeat unit may refer to aliphatic repeat units of the polymer chain.

In general, one or more copolyamides (e.g., a semi-aromatic copolyamide, an aliphatic copolyamide) may have a mole % repeat unit of the second repeat unit in an amount from about 10 to about 50, including all increments of 1 mole % therebetween. For instance, one or more copolyamides may have a mole % repeat unit of the second repeat unit in an amount of about 10% or more, such as about 15% or more, such as about 20% or more, such as about 25% or more, such as about 30% or more, such as about 35% or more, such as about 40% or more, such as about 45% or more, such as about 50% or less, such as about 45% or less, such as about 40% or less, such as about 35% or less, such as about 30% or less, such as about 25% or less, such as about 20% or less, such as about 15% or less. Notably, for a semi-aromatic copolyamide, the second repeat unit may refer to aromatic repeat units of the polymer chain.

Generally, one or more polyamides (e.g., one or more homopolyamides and/or one or more copolyamides) of the thermoplastic polymer composition may be aliphatic (i.e., contains only aliphatic monomer units) and/or semi-aromatic (i.e., contains both aliphatic and aromatic monomer units) In this respect, a combination of one or more aliphatic polyamides and/or one or more semi-aromatic polyamides, may be included in a thermoplastic polymer composition formed in accordance with the present disclosure. In general, one or more aliphatic polyamides and/or one or more semi-aromatic polyamides may be included in the first polyamide, the second polyamide, and/or the third polyamide.

Notably, an aliphatic polyamide (e.g., an aliphatic homopolyamide, an aliphatic copolyamide) may be derived from one or more carboxylic acid components (e.g., one or more dicarboxylic acid components) and one or more diamine components. In this respect, for instance, an aliphatic polyamide may have aliphatic repeat units derived from one or more aliphatic carboxylic acid components (e.g., one or more aliphatic dicarboxylic acid components) and one or more aliphatic diamine components. In one aspect, an aliphatic polyamide may have aliphatic repeat units derived from one or more aliphatic amino acids or lactams.

Notably, in one aspect, the thermoplastic polymer composition may comprise one or more aliphatic homopolyamides such as PA 6, PA 66, PA 610, PA 612, or a combination thereof. In one aspect, the thermoplastic polymer composition may comprise one or more aliphatic copolyamides, such as PA 66/6 (85/15) to PA 6/66 (85/15) (e.g., PA 66/6 (75/25)).

Notably, a semi-aromatic (e.g., a semi-aromatic copolyamide) polyamide may be derived from one or more carboxylic acid components (e.g., one or more dicarboxylic acid components) and one or more diamine components. In this respect, for instance, a semi-aromatic polyamide may have aromatic repeat units derived from one or more aromatic carboxylic acid components (e.g., one or more aromatic dicarboxylic acid components) and one or more aliphatic diamine components. Additionally, for instance, a semi-aromatic polyamide may have aromatic repeat units derived from one or more aliphatic carboxylic acid components (e.g., one or more aliphatic dicarboxylic acid components) and one or more aromatic diamine components. Further, for instance, a semi-aromatic polyamide may have aliphatic repeat units derived from one or more aliphatic carboxylic acid components (e.g., one or more aliphatic dicarboxylic acid components) and one or more aliphatic diamine components. In one aspect, a semi-aromatic polyamide (e.g., a semi-aromatic copolyamide) may have aliphatic repeat units derived from one or more aliphatic amino acids or lactams. Notably, in one aspect, a semi-aromatic copolyamide in accordance with the present disclosure may have at least 50 mole percent aliphatic repeat units.

Notably, in one aspect, the thermoplastic polymer composition may comprise one or more semi-aromatic copolyamides such as PA 612/6T (85/15) to (55/45) (e.g., PA 612/6T (75/25), PA 612/6T (70/30) and PA 612/6T (60/40)) and such as PA 610/6T (85/15) to (55/45) (e.g., PA 610/6T (80/20), PA 610/6T (75/25) and PA 610/6T (60/40)).

Generally, an aromatic dicarboxylic acid may be terephthalic acid, isophthalic acid, or 2,6-napthalenedioic acid. In one aspect, an aromatic dicarboxylic acid may have from 8 to 20 carbon atoms, including all increments of one carbon therebetween. For instance, an aromatic dicarboxylic acid may have 8 carbon atoms or more, such as 10 carbon atoms or more, such as 12 carbon atoms or more, such as 14 carbon atoms or more, such as 16 carbon atoms or more, such as 18 carbon atoms or more, such as 20 carbon atoms or less, such as 18 carbon atoms or less, such as 16 carbon atoms or less, such as 14 carbon atoms or less, such as 12 carbon atoms or less, such as 10 carbon atoms or less.

In general, an aliphatic dicarboxylic acid may be adipic acid, pimelic acid, suberic acid, azelaic acid, sebacic acid, decanedioic acid, dodecanedioic acid, tridecanedioic acid, tetradecanedioic acid, hexadecanedioic acid, or octadecanedioic acid. In one aspect, an aliphatic dicarboxylic acid may have from 6 to 20 carbon atoms, including all increments of one carbon therebetween. For instance, an aliphatic dicarboxylic acid may have 6 carbon atoms or more, such as 8 carbon atoms or more, such as 10 carbon atoms or more, such as 12 carbon atoms or more, such as 14 carbon atoms or more, such as 16 carbon atoms or more, such as 18 carbon atoms or more, such as 20 carbon atoms or less, such as 18 carbon atoms or less, such as 16 carbon atoms or less, such as 14 carbon atoms or less, such as 12 carbon atoms or less, such as 10 carbon atoms or less, such as 8 carbon atoms or less.

In general, an aliphatic diamine may be hexamethylenediamine (HMD), 1,10-decanediamine, 1,12-dodecanediamine, or 2-methyl-1,5-pentamentylenediamine. In one aspect, an aliphatic diamine may have from 4 to 20 carbon atoms, including all increments of one carbon therebetween. For instance, an aliphatic diamine may have 4 carbon atoms or more, such as 6 carbon atoms or more, such as 8 carbon atoms or more, such as 10 carbon atoms or more, such as 12 carbon atoms or more, such as 14 carbon atoms or more, such as 16 carbon atoms or more, such as 18 carbon atoms or more, such as 20 carbon atoms or less, such as 18 carbon atoms or less, such as 16 carbon atoms or less, such as 14 carbon atoms or less, such as 12 carbon atoms or less, such as 10 carbon atoms or less, such as 8 carbon atoms or less, such as 6 carbon atoms or less.

In general, an aliphatic amino acid (e.g., an aliphatic aminocarboxylic acid) or lactam may be 11-aminoundecanoic acid, 12-aminododecanoic acid, or their respective lactams. In one aspect, an aliphatic amino acid or lactam may have from 6 to 20 carbon atoms, including all increments of one carbon therebetween. For instance, an aliphatic amino acid or lactam may have 6 carbon atoms or more, such as 8 carbon atoms or more, such as 10 carbon atoms or more, such as 12 carbon atoms or more, such as 14 carbon atoms or more, such as 16 carbon atoms or more, such as 18 carbon atoms or more, such as 20 carbon atoms or less, such as 18 carbon atoms or less, such as 16 carbon atoms or less, such as 14 carbon atoms or less, such as 12 carbon atoms or less, such as 10 carbon atoms or less, such as 8 carbon atoms or less.

As previously disclosed herein, the thermoplastic polymer composition may include one or more polyamides. For instance, the thermoplastic polymer composition may include a first polyamide, a second polyamide, and a third polyamide. Generally, the thermoplastic polymer composition may include from about 20 wt. % to about 70 wt. % of a PA 6 homopolymer, such as about 20 wt. % or more, such as about 30 wt. % or more, such as about 35 wt. % or more, such as about 40 wt. % or more, such as about 45 wt. % or more, such as about 50 wt. % or more, such as about 55 wt. % or more, such as about 60 wt. % or more, such as about 70 wt. % or less, such as about 60 wt. % or less, such as about 55 wt. % or less, such as about 50 wt. % or less, such as about 45 wt. % or less, such as about 40 wt. % or less, such as about 35 wt. % or less, such as about 30 wt. % or less.

Generally, the thermoplastic polymer composition may include from about 20 wt. % to about 70 wt. % of a PA 66/6 copolymer, such as about 20 wt. % or more, such as about 30 wt. % or more, such as about 35 wt. % or more, such as about 40 wt. % or more, such as about 45 wt. % or more, such as about 50 wt. % or more, such as about 55 wt. % or more, such as about 60 wt. % or more, such as about 70 wt. % or less, such as about 60 wt. % or less, such as about 55 wt. % or less, such as about 50 wt. % or less, such as about 45 wt. % or less, such as about 40 wt. % or less, such as about 35 wt. % or less, such as about 30 wt. % or less.

Generally, the thermoplastic polymer composition may include from about 2 wt. % to about 30 wt. % of a PA 610/6T copolymer, such as about 2 wt. % or more, such as about 5 wt. % or more, such as about 10 wt. % or more, such as about 15 wt. % or more, such as about 20 wt. % or more, such as about 25 wt. % or more, such as about 30 wt. % or less, such as about 25 wt. % or less, such as about 20 wt. % or less, such as about 15 wt. % or less, such as about 10 wt. % or less, such as about 5 wt. % or less.

Generally, the thermoplastic polymer composition may include from about 2 wt. % to about 30 wt. % of a PA 612/6T copolymer, such as about 2 wt. % or more, such as about 5 wt. % or more, such as about 10 wt. % or more, such as about 15 wt. % or more, such as about 20 wt. % or more, such as about 25 wt. % or more, such as about 30 wt. % or less, such as about 25 wt. % or less, such as about 20 wt. % or less, such as about 15 wt. % or less, such as about 10 wt. % or less, such as about 5 wt. % or less.

Generally, the thermoplastic polymer composition may include from about 2 wt. % to about 20 wt. % of a PA 610 homopolymer, such as about 2 wt. % or more, such as about 5 wt. % or more, such as about 10 wt. % or more, such as about 15 wt. % or more, such as about 20 wt. % or less, such as about 15 wt. % or less, such as about 10 wt. % or less, such as about 5 wt. % or less.

Generally, the thermoplastic polymer composition may include from about 2 wt. % to about 20 wt. % of a PA 612 homopolymer, such as about 2 wt. % or more, such as about 5 wt. % or more, such as about 10 wt. % or more, such as about 15 wt. % or more, such as about 20 wt. % or less, such as about 15 wt. % or less, such as about 10 wt. % or less, such as about 5 wt. % or less. A PA 612 homopolymer may be a component of the first polyamide, the second polyamide, and/or the third polyamide.

### Impact Modifier

In general, a thermoplastic polymer composition formed in accordance with the present disclosure may include one or more impact modifiers. In some aspects, the impact modifier may be nonfunctionalized or functionalized. When present, one or more impact modifiers may include, without limitation, one or more polymeric impact modifiers in which the impact modifier comprises an acid, epoxy, or anhydride functional group. Such functional groups are usually incorporated into the impact modifier by grafting small molecules onto an already existing polymer backbone or by directly copolymerizing a monomer containing the desired functional group into the polymer backbone of the impact modifier. For instance, as an example of a suitable type of grafted impact modifier, maleic anhydride may be grafted onto a hydrocarbon rubber (e.g., EPDM) and/or an olefinic thermoplastic (e.g., an ethylene/α-olefin copolymer, an α-olefin being a straight chain olefin with a terminal double bond such as propylene or 1-octene) using free-radical grafting techniques. The resulting grafted polymer may have carboxylic anhydride and/or carboxyl groups attached to it. In one particular aspect, the impact modifier may be a maleic anhydride grafted ethylene copolymer.

Functionalized ethylene copolymers are an example of a polymeric impact modifier wherein the functional groups are directly copolymerized into the polymer backbone, for instance, a direct copolymer of ethylene and a (meth)acrylic acid monomer. The ethylene copolymers may also include acrylate monomers, methacrylate monomers, or a mixture of the two, in addition to (meth)acrylic acid monomers. Examples of acrylate and methacrylate monomers include ethyl (meth)acrylate, n-butyl(meth)acrylate, i-butyl(meth)acrylate and cyclohexyl (meth)acrylate. Useful compounds comprising functional groups include (meth)acrylic acid, 2-hydroxyethyl(meth)acrylic acid, glycidyl(meth)acrylate, and 2-isocyanatoethyl(meth)acrylic acid. The prefix “(meth)” as used herein refers to an optional methyl group. For example, “(meth)acrylic acid” refers to acrylic acid, methacrylic acid, or to both acrylic and methacrylic acid. Suitable functionalized ethylene copolymers for use as impact modifiers include without limitation those described in U.S. Pat. No. 4,174,358.

Another suitable type of impact modifier is a polymer comprising carboxylic acid metal salts. Such polymers may be made by grafting a carboxylic acid or carboxylic acid anhydride containing compound to the polymer or by directly copolymerizing acid or acid anhydride-containing comonomers.

Subsequently, some or all of the acid or anhydride groups are neutralized. Useful materials of this sort include Surlyn™ ionomers available from Dow Chemical Company, Midland Mich. 48674 USA, and neutralized maleic anhydride grafted ethylene/α-olefin polymers having metal cations as counterions. Preferred metal cations for these carboxylate salts include Na, Zn, Li, Mg and Mn cations.

Herein the term “ethylene copolymers” includes ethylene dipolymers, i.e., copolymers of ethylene with one comonomer; ethylene terpolymers i.e., copolymers of ethylene with two comonomers; and ethylene multi-polymers, i.e., copolymers having greater than three different repeat units. Ethylene copolymers useful as impact modifiers include those selected from the group consisting of ethylene copolymers of the formula E/X/Y wherein:
E represents the repeat unit derived from ethylene;
X represents repeat units derived from one or more comonomers of the formula

CH₂═CH(R¹)—C(O)—OR²

wherein R¹ is H, CH₃, or C₂H₅, and R² is an alkyl group having 1 to 8 carbon atoms; or X represents repeat units derived from vinyl acetate alone or in combination with one or more other comonomers X; wherein the amount of X is from 0 to 50 weight % of the E/X/Y copolymer; Y represents repeat units derived from one or more monomers selected from the group consisting of carbon monoxide, sulfur dioxide, acrylonitrile, maleic anhydride, maleic acid diesters, (meth)acrylic acid, maleic acid, maleic acid monoesters, itaconic acid, fumaric acid, fumaric acid monoesters and potassium, sodium and zinc salts of said preceding acids, glycidyl(meth)acrylate, 2-hydroxyethyl(meth)acrylate, 2-isocyanatoethyl(meth)acrylate and glycidyl vinyl ether; wherein the amount of Y is from 0.5 to 35 weight % of the E/X/Y copolymer, and preferably 0.5 to 20 weight percent of the E/X/Y copolymer, and E is the remainder weight percent and preferably comprises 40-90 weight percent of the E/X/Y copolymer.

In some aspects, a functionalized impact modifier may contain from about 0.1 wt. % to about 15 wt. %, including all increments of about 0.01 wt. % therebetween, of repeat units and/or grafted molecules containing functional groups or carboxylate salts (including the metal). For instance, a functionalized impact modifier may contain about 0.1 wt. % of repeat units and/or grafted molecules containing functional groups or carboxylate salts (including the metal) or more, such as about 0.2 wt. % or more, such as about 0.3 wt. % or more, such as about 0.4 wt. % or more, such as about 0.5 wt. % or more, such as about 1 wt. % or more, such as about 2 wt. % or more, such as about 4 wt. % or more, such as about 6 wt. % or more, such as about 8 wt. % or more, such as about 10 wt. % or more, such as about 12 wt. % or more, such as about 14 wt. % or more, such as about 15 wt. % or less, such as about 14 wt. % or less, such as about 12 wt. % or less, such as about 10 wt. % or less, such as about 8 wt. % or less, such as about 6 wt. % or less, such as about 4 wt. % or less, such as about 2 wt. % or less, such as about 1 wt. % or less, such as about 0.5 wt. % or less, such as about 0.4 wt. % or less, such as about 0.3 wt. % or less, such as about 0.2 wt. % or less by weight of the impact modifier. In general, there may be more than one type of functional monomer present in the polymeric impact modifier, and/or more than one polymeric impact modifier.

Nonfunctionalized impact modifiers may also be present in addition to a functionalized impact modifier. Nonfunctionalized impact modifiers include polymers such as ethylene/α-olefin/diene (EPDM) rubber, polyolefins including polyethylene (PE) and polypropylene, and ethylene/α-olefin (EP) elastomers such as ethylene/1-octene copolymer, and the like such as those commercial copolymers under the ENGAGE® brand from Dow Chemical, Midland Mich. Other nonfunctional impact modifiers include the styrene-containing polymers including acrylonitrile styrene copolymer, acrylonitrile-butadiene-styrene copolymer, styrene-isoprene-styrene copolymer, styrene-hydrogenated isoprene-styrene copolymer, styrene-butadiene-styrene copolymer, styrene-hydrogenated butadiene-styrene copolymer, styrenic block copolymer, and polystyrene. For example, acrylonitrile-butadiene-styrene, or ABS, is a terpolymer made by polymerizing styrene and acrylonitrile in the presence of polybutadiene. The proportions can vary from 15 to 35% acrylonitrile, 5 to 30% butadiene and 40 to 60% styrene. The result is a long chain of polybutadiene criss-crossed with shorter chains of polystyrene acrylonitrile).

In general, a thermoplastic polymer composition may include an impact modifier (e.g., a maleic anhydride grafted ethylene copolymer) in an amount from about 5 wt. % to about 50 wt. %, including all increments of about 0.01 wt. % therebetween. For instance, a thermoplastic polymer composition may include an impact modifier (e.g., a maleic anhydride grafted ethylene copolymer) in an amount of about 5 wt. % or more, such as about 10 wt. % or more, such as about 15 wt. % or more, such as about 20 wt. % or more, such as about 25 wt. % or more, such as about 30 wt. % or more, such as about 35 wt. % or more, such as about 40 wt. % or more, such as about 45 wt. % or more, such as about 50 wt. % or less, such as about 45 wt. % or less, such as about 40 wt. % or less, such as about 35 wt. % or less, such as about 30 wt. % or less, such as about 25 wt. % or less, such as about 20 wt. % or less, such as about 15 wt. % or less, such as about 10 wt. % or less by weight of the thermoplastic polymer composition.

### Stabilizers

In general, the thermoplastic polymer composition may contain one or more stabilizers. Notably, the one or more stabilizers may include one or more antioxidants.

In one aspect, a stabilizer that can be incorporated into the thermoplastic polymer composition is a heat stabilizer that comprises a hindered phenolic antioxidant. Examples of such phenolic antioxidants include, for instance, calcium bis(ethyl 3,5-di-tert-butyl-4-hydroxybenzylphosphonate) (Irganox® 1425); terephthalic acid, 1,4-dithio-,S,S-bis(4-tert-butyl-3-hydroxy-2,6-dimethylbenzyl) ester (Cyanox® 1729); triethylene glycol bis(3-tert-butyl-4-hydroxy-5-methylhydrocinnamate); hexamethylene bis(3,5-di-tert-butyl-4-hydroxyhydrocinnamate (Irganox® 259); 1,2-bis(3,5,di-tert-butyl-4-hydroxyhydrocinnamoyl) hydrazide (Irganox® 1024); 4,4′-di-tert-octyldiphenamine (Naugalube@ 438R); phosphonic acid, (3,5-di-tert-butyl-4-hydroxybenzyl)-,dioctadecyl ester (Irganox® 1093); 1,3,5-trimethyl-2,4,6-tris(3′,5′-di-tert-butyl-4′ hydroxybenzyl)benzene (Irganox® 1330); 2,4-bis(octylthio)-6-(4-hydroxy-3,5-di-tert-butylanilino)-1,3,5-triazine (Irganox® 565); isooctyl 3-(3,5-di-tert-butyl-4-hydroxyphenyl) propionate (Irganox® 1135); octadecyl 3-(3,5-di-tert-butyl-4-hydroxyphenyl) propionate (Irganox®) 1076); 3,7-bis(1,1,3,3-tetramethylbutyl)-10H-phenothiazine (Irganox® LO 3); 2,2′-methylenebis(4-methyl-6-tert-butylphenol) monoacrylate (Irganox® 3052); 2-tert-butyl-6-[1-(3-tert-butyl-2-hydroxy-5-methylphenyl)ethyl]-4-methylphenyl acrylate (Sumilizer@) TM 4039); 2-[1-(2-hydroxy-3,5-di-tert-pentylphenyl)ethyl]-4,6-di-tert-pentylphenyl acrylate (Sumilizer® GS); 1,3-dihydro-2H-Benzimidazole (Sumilizer® MB); 2-methyl-4,6-bis[(octylthio)methyl]phenol (Irganox® 1520); N,N′-trimethylenebis-[3-(3,5-di-tert-butyl-4-hydroxyphenyl) propionamide (Irganox® 1019); 4-n-octadecyloxy-2,6-diphenylphenol (Irganox® 1063); 2,2′-ethylidenebis[4,6-di-tert-butylphenol] (Irganox®) 129); N N′-hexamethylenebis(3,5-di-tert-butyl-4-hydroxyhydrocinnamamide) (Irganox® 1098); diethyl(3,5-di-tert-butyl-4-hydroxybenxyl)phosphonate (Irganox® 1222); 4,4′-di-tert-octyldiphenylamine (Irganox® 5057); N-phenyl-1-napthalenamine (Irganox® L 05); tris [2-tert-butyl-4-(3-ter-butyl-4-hydroxy-6-methylphenylthio)-5-methyl phenyl]phosphite (Hostanox® OSP 1); zinc dinonyidithiocarbamate (Hostanox® VP—ZNCS 1); 3,9-bis[1,1-dimethyl-2-[(3-tert-butyl-4-hydroxy-5-methylphenyl) propionyloxy]ethyl]-2,4,8,10-tetraoxaspiro [5.5]undecane (Sumilizer@ AG80); pentaerythrityl tetrakis [3-(3,5-di-tert-butyl-4-hydroxyphenyl) propionate] (Irganox® 1010); ethylene-bis(oxyethylene)bis[3-(5-tert-butyl-4-hydroxy-m-tolyl)-propionate (Irganox® 245); 3,5-di-tert-butyl-4-hydroxytoluene (Lowinox BHT, Chemtura) and the like.

Some examples of suitable sterically hindered phenolic antioxidants for use in the present composition are triazine antioxidants having the following general formula:

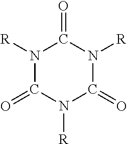

wherein, each R is independently a phenolic group, which may be attached to the triazine ring via a C₁ to C₅ alkyl or an ester substituent. Preferably, each R is one of the following formula (I)—(III):

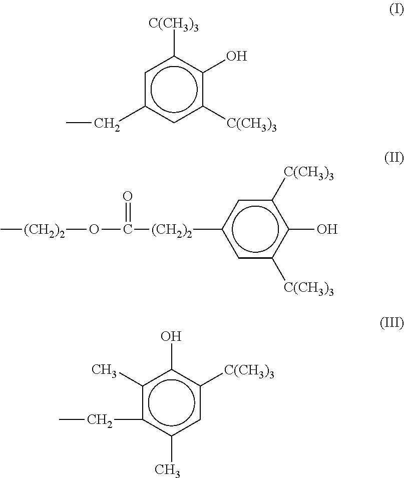

Commercially available examples of such triazine-based antioxidants may be obtained from American Cyanamid under the designation Cyanox® 1790 (wherein each R group is represented by the Formula III) and from Ciba Specialty Chemicals under the designations Irganox® 3114 (wherein each R group is represented by the Formula I) and Irganox® 3125 (wherein each R group is represented by the Formula II).

In one embodiment, the heat stabilizer can comprise iodobis(triphenylphosphino) copper. Alternatively, the heat stabilizer can be a metal halide, such as a metal iodide. The metal iodide can be a potassium iodide, a copper iodide, or mixtures thereof (e.g., CuI/KI).

In one aspect, the heat stabilizer can include a copper compound that can include a copper (I) salt, copper (II) salt, copper complex, or a combination thereof. For example, the copper (I) salt may be CuI, CuBr, CuCl, CuCN, CU₂O, or a combination thereof and/or the copper (II) salt may be copper acetate, copper stearate, copper sulfate, copper propionate, copper butyrate, copper lactate, copper benzoate, copper nitrate, CuO, CuCl₂, or a combination thereof. In certain embodiments, the copper compound may be a copper complex that contains an organic ligand, such as alkyl phosphines, such as trialkylphosphines (e.g., tris-(n-butyl)phosphine) and/or dialkylphosphines (e.g., 2-bis-(dimethylphosphino)-ethane); aromatic phosphines, such as triarylphosphines (e.g., triphenylphosphine or substituted triphenylphosphine) and/or diarylphosphines (e.g., 1,6-(bis-(diphenylphosphino))-hexane, 1,5-bis-(diphenylphosphino)-pentane, bis-(diphenylphosphino) methane, 1,2-bis-(diphenylphosphino) ethane, 1,3-bis-(diphenylphosphino) propane, 1,4-bis-(diphenylphosphino) butane, etc.); mercaptobenzimidazoles; glycines; oxalates; pyridines (e.g., bypyridines); amines (e.g., ethylenediaminetetraacetates, diethylenetriamines, triethylenetetramines, etc.); acetylacetonates; and so forth, as well as combinations of the foregoing. Particularly suitable copper complexes for use in the heat stabilizer may include, for instance, copper acetylacetonate, copper oxalate, copper EDTA, [Cu(PPh₃)₃X], [Cu₂X(PPH₃)₃], [Cu(PPh₃)X], [Cu(PPh₃)₂X], [CuX(PPh₃)-2,2′-bypyridine], [CuX(PPh₃)-2,2′-biquinoline)], or a combination thereof, wherein PPh₃ is triphenylphosphine and X is Cl, Br, I, CN, SCN, or 2-mercaptobenzimidazole. Other suitable complexes may likewise include 1,10-phenanthroline, o-phenylenebis(dimethylarsine), 1,2-bis(diphenylphosphino)-ethane, terpyridyl, and so forth.

When employed, the copper complexes may be formed by reaction of copper ions (e.g., copper (I) ions) with the organic ligand compound (e.g., triphenylphosphine or mercaptobenzimidazole compounds). For example, these complexes can be obtained by reacting triphenylphosphine with a copper (I) halide suspended in chloroform (G. Kosta, E. Reisenhofer and L. Stafani, J. Inorg. Nukl. Chem. 27 (1965) 2581). However, it is also possible to reductively react copper (II) compounds with triphenylphosphine to obtain the copper (I) addition compounds (F. U. Jardine, L. Rule, A. G. Vohrei, J. Chem. Soc. (A) 238-241 (1970)). However, the complexes used according to the invention can also be produced by any other suitable process. Suitable copper compounds for the preparation of these complexes are the copper (I) or copper (II) salts of the hydrogen halide acids, the hydrocyanic acid or the copper salts of the aliphatic carboxylic acids. Examples of suitable copper salts are copper (I) chloride, copper (I) bromide, copper (I) iodide, copper (I) cyanide, copper (II) chloride, copper (II) acetate, copper (II) stearate, etc., as well as combinations thereof. Copper (I) iodide and copper (I) cyanide are particularly suitable.

In addition to a copper compound, the heat stabilizer may also contain a halogen-containing synergist. When employed, the copper compound and halogen-containing synergist are typically used in quantities to provide a copper:halogen molar ratio of from about 1:1 to about 1:50, in some embodiments from about 1:4 to about 1:20, and in some embodiments, from about 1:6 to about 1:15. For example, the halogen content of the thermoplastic polymer composition may be from about 1 ppm to about 10,000 ppm, in some embodiments from about 50 ppm to about 5,000 ppm, in some embodiments from about 100 ppm to about 2,000 ppm, and in some embodiments, from about 300 ppm to about 1,500 ppm. In one aspect, the halogen content of the thermoplastic polymer composition is less than about 1000 ppm, such as less than about 600 ppm, such as less than about 500 ppm, such as less than about 400 ppm.

The halogenated synergist generally includes an organic halogen-containing compound, such as aromatic and/or aliphatic halogen-containing phosphates, aromatic and/or aliphatic halogen-containing hydrocarbons; and so forth, as well as combinations thereof. For example, suitable halogen-containing aliphatic phosphates may include tris(halohydrocarbyl)-phosphates and/or phosphonate esters. Tris(bromohydrocarbyl)phosphates (brominated aliphatic phosphates) are particularly suitable. In particular, in these compounds, no hydrogen atoms are attached to an alkyl C atom which is in the alpha position to a C atom attached to a halogen. This minimizes the extent that a dehydrohalogenation reaction can occur which further enhances stability of the thermoplastic polymer composition. Specific exemplary compounds are tris(3-bromo-2,2-bis(bromomethyl) propyl)phosphate, tris(dibromoneopentyl)phosphate, tris(trichloroneopentyl)phosphate, tris(bromodichlorneopentyl)phosphate, tris(chlordibromoneopentyl)phosphate, tris(tribromoneopentyl)phosphate, or a combination thereof. Suitable halogen-containing aromatic hydrocarbons may include halogenated aromatic polymers (including oligomers), such as brominated styrene polymers (e.g., polydibromostyrene, polytribromostyrene, etc.); halogenated aromatic monomers, such as brominated phenols (e.g., tetrabromobisphenol-A); and so forth, as well as combinations thereof.

The thermoplastic polymer composition can optionally include a light stabilizer which may comprise a hindered amine light stabilizer. Regardless of the compound from which it is derived, the hindered amine may be an oligomeric or polymeric compound having a number average molecular weight of about 1,000 or more, in some embodiments from about 1000 to about 20,000, in some embodiments from about 1500 to about 15,000, and in some embodiments, from about 2000 to about 5000. Such compounds typically contain at least one 2,2,6,6-tetraalkylpiperidinyl group (e.g., 1 to 4) per polymer repeating unit. Further, low molecular weight hindered amines may also be employed in the thermoplastic polymer composition. Such hindered amines are generally monomeric in nature and have a molecular weight of about 1000 or less, in some embodiments from about 155 to about 800, and in some embodiments, from about 300 to about 800.

Examples of light stabilizers that may be incorporated into the present disclosure include a benzendicarboxamide. The light stabilizer may also comprise any compound which is derived from an alkylsubtituted piperidyl, piperidinyl or piperazinone compound or a substituted alkoxypiperidinyl. Other suitable HALS are those that are derivatives of 2,2, 6,6-tetramethyl piperidine. Preferred specific examples of HALS include: ˜2,2, 6,6-tetramethyl-4-piperidinone, ˜2,2, 6,6-tetramethyl-4-piperidinol, ˜bis-(2, 2, 6,6-tetramethyl-4-piperidinyl)-sebacate, ˜mixtures of esters of 2,2,6,6-tetramethyl-4-piperidinol and fatty acids, ˜bis-(2,2,6,6-tetramethyl-4-piperidinyl)-succinate, ˜bis-(1-octyloxy-2,2,6,6-tetramethyl-4-piperidinyl)-sebacate, ˜bis-(1,2,2,6,6-pentamethyl-4-piperidinyl)-sebacate, ˜tetrakis-(2,2,6,6-tetramethyl-4-piperidyl)-1,2,3,4-butane-tetracarboxylate, ˜N-butyl-2,2,6,6-tetramethyl-4-piperidinamine, ˜N,N′-bis-(2,2,6,6-tetramethyl-4-piperidyl)-hexane-1,6-diamine, ˜2.2′-[(2.2.6.6-tetramethyl-4-piperidinyl)-imino]-bis-[ethanol], ˜5-(2.2.6.6-tetramethyl-4-piperidinyl)-2-cyclo-undecyl-oxazole), ˜mixture of: 2,2,4,4 tetramethyl-21-oxo-7-oxa-3.20-diazadispiro [5.1.11.2]heneicosane-20-propionic acid dodecylester and 2.2.4.4 tetramethyl-21-oxo-7; oxa-3,20-diazadispiro [5,1,11,2]-heneicosane-20-propionic acid; tetradecyl ester, ˜diacetam 5 (CAS registration number: 76505-58-3), ˜propanedioic acid, [(4-methoxyphenyl)methylene]-, bis(1,2,2,6,6-pentamethyl-4-piperidinyl) ester, ˜1,3-benzendicarboxamide, N,N′-bis(2,2,6,6-tetramethyl-4-piperidinyl), ˜3-dodecyl-1-(2,2,6,6-tetramethyl-4-piperidyl)-pyrrolidin-2,5-dione, ˜formamide, N,N′-1,6-hexanediylbis[N-(2,2,6,6-tetramethyl-4-piperidinyl, ˜3-dodecyl-1-(1,2,2, 6,6-pentamethyl-4-piperidyl)-pyrrolidin-2,5-dione, ˜1,5-Dioxaspiro(5,5) undecane 3,3-dicarboxylic acid, bis(2,2,6,6-tetramethyl-4-peridinyl) ester, ˜1,5-Dioxaspiro(5,5) undecane 3,3-dicarboxylic acid, bis(1,2,2,6,6-pentamethyl-4-peridinyl) ester, ˜bis(1,2,2,6,6-penta methyl-4-piperidyl) (3,5-di-t-butyl-4-hydroxybenzyl)-butylpropanedioate, ˜tetrakis-(1,2,2,6,6-penta-methyl-4-piperidyl)-1,2,3,4-butane-tetra--carboxylate, ˜1,2,3,4-butanetetracarboxylic acid, tetrakis(2,2,6,6-tetramethyl-4-piperidinyl) ester, ˜1,2,3,4-butane-tetracarboxylic acid-1,2,3-tris(1,2,2,6,6-pentamethyl-4-piperidinyl)-4-tridecylester, ˜8-acetyl-3-dodecyl-7,7,9,9-tetra methyl-1,3,8-triazaspiro(4,5) decane-2,4-dione, ˜N-2,2,6,6-tetrametyl-4-piperidinyl-N-amino-oxamide, ˜4-acryloyloxy-1,2,2,6,6-pentamethyl-4-piperidine, ˜1,5,8,12-tetrakis [2′,4′-bis(1″,2″,2″,6″,6″-pentamethyl-4″-piperidinyl(butyl)amino)-1′,3′,5′-tr-iazin-6′-yl]-1,5,8, 12-tetraazadodecane, ˜1,1′-(1,2-ethane-di-yl)-bis-(3,3′, 5,5′-tetra-methyl-piperazinone) (Good rite 3034), ˜propane amide, 2-methyl-N-(2,2,6,6-tetramethyl-4-piperidinyl)-2-[(2,2,6,6-tetramethyl-4-piperidinyl)amino], ˜oligomer of N-(2-hydroxyethyl)-2,2,6,6-tetramethyl-4-piperidinol and succinic acid, ˜poly [[6-[(1,1,3,3-tetramethylbutyl)amino]-s-triazine-2,4-diyl][2,2,6,6-tetram-ethyl-4-piperidinyl)imino]hexamethylene [(2,2,6,6-tetramethyl-4-piperidinyl)imino]], ˜poly [(6-morfoline-S-triazine-2.4-diyl) [(2.2.6.6-tetramethyl-4-piperidinyl)-imino]hexamethylene-[(2.2.6.6-tetram-ethyl-4-piperidinyl)-imino]], ˜poly [(6-morpholino-s-triazine-2.4-diyl) [1.2.2.6.6-penta-methyl-4-piperidyl)imino]-hexamethylene [(2,2,6,6 tetra-methyl-4-piperidyl)imino]], ˜poly methylpropyl-3-oxy-[4 (2.2.6.6-tetrametyl)-piperidinyl)]-siloxane copolymer of a-methylstyrene and n-(2.2.6.6-tetramethyl-piperidinyl)-4-maleimide and N-stearyl-maleimide, ˜1,2,3,4-butane tetracarboxylic acid, polymer with 8,8,8′,8′-tetramethyl-2,4,8,10-tetraoxaspiro [5,5]undecane-3,9-diethanol, 1,2,2, 6,6-pentamethyl-4-piperidinyl ester, ˜1,2, 3,4-butanetetracarboxylic acid, polymer with 8,8,8′,8′-tetramethyl-2,4,8,10-tetraoxaspiro [5,5]undecane-3,9-diethanol, 2,2,6,6-tetramethyl-4-piperidinyl ester, ˜oligomer of 7-Oxa-3,20-diazadispiro [5,1,11,2]heneicosan-21-one, 2,2,4,4-tetramethyl-20-(oxiranylmethyl), ˜1,3,5-Triazine-2,4,6-triamine, N, N″-[1,2-ethanediylbis[[4,6-bis[butyl(1,2,2,6,6-pentamethyl-4-iperidinyl)amino]-1,3,5-triazine--2-yl]imino]-3,1-propanediyl]]-bis[N. N″-dibutyl-N. N″-bis(1.2.2.6.6-pentamethyl-4-piperidinyl), ˜1.3-Propanediamine, N, N-1,2-ethanediylbis-, polymer with 2,4,6-trichloro-1,3,5-triazine, reaction products with N-butyl-2,2,6,6-tetramethyl-4-piperidinamine, ˜1.6-Hexanediamine, N,N′-bis(2,2,6,6-tetramethyl-4piperidinyl)-polymer with 2,4,6-trichloro-1,3,5-triazine, reaction products with N-butyl-1-butanamine and N-butyl-2,2,6,6-tetramethyl-4-piperidinamine, ˜2,9,11,13,15,22,24,26,27,28-Decaazatricyclo[21,3,1,110,14]octacosa-1(27), 10,12,14 (28),23,25-hexaene-12, 25-diamine, N,N′-bis(1,1,3,3-tetramethylbutyl)-2,9,15,22-tetrakis(2,2,6,6-tetramethyl-4-piperidinyl)-, ˜1,1,1″-(1,3,5-Triazine-2,4,6-triyltris((cyclohexylimino)-2,1-ethanediyl)tris(3,3,5,5-tetramethylpiperazinone), ˜1,1,1″-(1,3,5-Triazine-2,4,6-triyltris((cyclohexylimino)-2,1-ethylenediyl)tris(3,3,4,5,5-tetramethylpiperazinone), ˜1,6-hexanediamine, N,N′-bis(2,2,6,6-tetramethyl-4-piperidinyl)-, polymer with 2,4,6-trichloro-1,3,5-triazine, reaction products with 3-bromo-1-propene, nbutyl-1-butanamine and N-butyl-2,2,6,6-tetramethyl-4-piperidinamine, oxidised, hydrogenated, ˜Alkenes, (C20-24)-4 alpha-, polymers with maleic anhydride, reaction products with 2,2,6,6-tetramethyl-4-piperidinamine, ˜N-2,2,6,6-tetramethyl-4-piperidinyl-N-amino-oxamide; 4-acryloyloxy-1,2,2,6,6-pentamethyl-4-piperidine; HALS PB-41 or mixtures thereof.

In some aspects, one or more stabilizers containing secondary amines may also be employed in the thermoplastic polymer composition. The secondary amines may be aromatic in nature, such as N-phenyl naphthylamines (e.g., Naugard® PAN from Uniroyal Chemical); diphenylamines, such as 4,4′-bis(dimethylbenzyl)-diphenylamine (e.g., Naugard® 445 from Uniroyal Chemical); p-phenylenediamines (e.g., Wingstay@ 300 from Goodyear); quinolones, and so forth. Particularly suitable secondary amines are oligomeric or polymeric amines, such as homo- or copolymerized polyamides. Examples of such polyamides may include nylon 3 (poly-β-alanine), nylon 6, nylon 10, nylon 11, nylon 12, nylon 6/6, nylon 6/9, nylon 6/10, nylon 6/11, nylon 6/12, polyesteramide, polyamideimide, polyacrylamide, and so forth. In one particular embodiment, the amine is a polyamide terpolymer having a melting point in the range from 120° C. to 220° C. Suitable terpolymers may be based on the nylons selected from the group consisting of nylon 6, nylon 6/6, nylon 6/9, nylon 6/10 and nylon 6/12, and may include nylon 6-66-69; nylon 6-66-610 and nylon 6-66-612. One example of such a nylon terpolymer is a terpolymer of nylon 6-66-610 and is commercially available from Celanese under the designation Elvamide® 8063R. Secondary amines may constitute from about 0.01 wt. % to about 2 wt. %, of the entire polymer composition.

In one aspect, the thermoplastic polymer composition may contain a phosphorous-containing antioxidant. The phosphorous-containing antioxidant may include, for instance, a phosphonite having the structure:

[R—P(OR₁)₂]ₘ (1)
wherein,
R is a mono- or polyvalent aliphatic, aromatic, or heteroaromatic organic radical, such as a cyclohexyl, phenyl, phenylene, and/or biphenyl radical; and
R¹ is independently a compound of the structure (II)

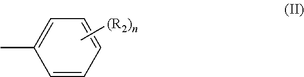

or the two radicals R¹ form a bridging group of the structure (III)

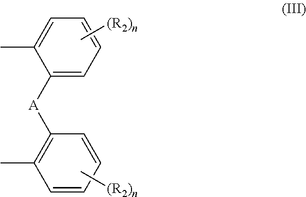

where
A is a direct bond, O, S, C1-18 alkylene (linear or branched), or C1-18 alkylidene (linear or branched);
R² is independently C1-12 alkyl(linear or branched), C1-12 alkoxy, or C5-12 cycloalkyl; n is from 0 to 5, in some embodiments from 1 to 4, and in some embodiments, from 2 to 3, and m is from 1 to 4, in some embodiments from 1 to 3, and in some embodiments, from 1 to 2 (e.g., 2).

Particular preference is given to compounds which, on the basis of the preceding claims, are prepared via a Friedel-Crafts reaction of an aromatic or heteroaromatic system, such as benzene, biphenyl, or diphenyl ether, with phosphorus trihalides, preferably phosphorus trichloride, in the presence of a Friedel-Crafts catalyst, such as aluminum chloride, zinc chloride, iron chloride, etc., and a subsequent reaction with the phenols underlying the structures (II) and (III). Mixtures with phosphites produced in the specified reaction sequence from excess phosphorus trihalide and from the phenols described above are expressly also covered by the invention.

In one particular embodiment, R¹ is a group of the structure (II). Among this group of compounds, antioxidants of the general structure (V) are particularly suitable:

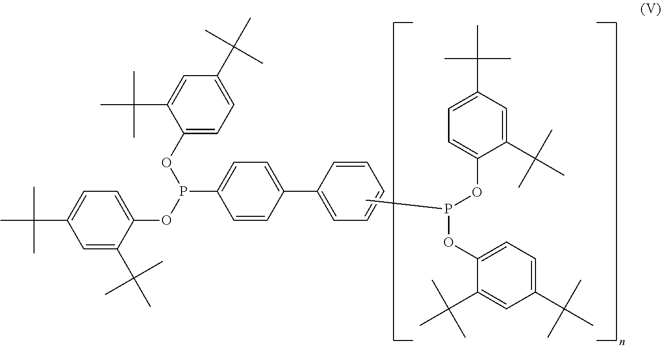

wherein, n is as defined above.

In one particular embodiment, for instance, n in formula (V) is 1 such that the antioxidant is tetrakis(2,4-di-tert-butylphenyl) 4,4′-biphenylene-diphosphonite.

In one embodiment, the antioxidant can be a reaction product of 2,4-di-tert-butylphenol, phosphorous trichloride, and 1,1′-biphenyl.

In one embodiment, the antioxidant might be a mixture of a hindered phenolic antioxidant and a phosphite. For instance, the antioxidant might be a mixture of N N′-hexamethylenebis(3,5-di-tert-butyl-4-hydroxyhydrocinnamamide) and tris(2,4-di-tert-butylphenyl)phosphite.

In general, a thermoplastic polymer composition formed in accordance with the present disclosure may contain one or more stabilizers (e.g., one or more heat stabilizers, one or more light stabilizers, etc.) in an amount from about 0 wt. % to about 5 wt. %, including all increments of 0.01 wt. % therebetween. For instance, a thermoplastic polymer composition formed in accordance with the present disclosure may contain one or more stabilizers in an amount of about 0 wt. % or more, such as about 0.01 wt. % or more, such as about 0.05 wt. % or more, such as about 0.1 wt. % or more, such as about 0.2 wt. % or more, such as about 0.25 wt. % or more, such as about 0.5 wt. % or more, such as about 0.75 wt. % or more, such as about 1 wt. % or more, such as about 1.25 wt. % or more, such as about 1.5 wt. % or more, such as about 2 wt. % or more, such as about 3 wt. % or more, such as about 4 wt. % or more, such as about 5 wt. % or less, such as about 4 wt. % or less, such as about 3 wt. % or less, such as about 2 wt. % or less, such as about 1.5 wt. % or less, such as about 1.25 wt. % or less, such as about 1 wt. % or less, such as about 0.75 wt. % or less, such as about 0.5 wt. % or less, such as about 0.25 wt. % or less, such as about 0.2 wt. % or less, such as about 0.1 wt. % or less, such as about 0.05 wt. % or less by weight of the thermoplastic polymer composition.

In addition to the components noted above, the thermoplastic polymer composition may also contain a variety of other components. Examples of such optional components may include, for instance, reinforcing and/or EMI fillers, compatibilizers, particulate fillers, lubricants, colorants, flow modifiers, pigments, and other materials added to enhance properties and processability. When EMI shielding properties are desired, for instance, an EMI filler may be employed. The EMI filler is generally formed from an electrically conductive material that can provide the desired degree of electromagnetic interference shielding. In certain embodiments, for instance, the material contains a metal, such as stainless steel, aluminum, zinc, iron, copper, silver, nickel, gold, chrome, etc., as well alloys or mixtures thereof. The EMI filler may also possess a variety of different forms, such as particles (e.g., iron powder), flakes (e.g., aluminum flakes, stainless steel flakes, etc.), or fibers. Particularly suitable EMI fillers are fibers that contain a metal. In such embodiments, the fibers may be formed from primarily from the metal (e.g., stainless steel fibers) or the fibers may be formed from a core material that is coated with the metal. When employing a metal coating, the core material may be formed from a material that is either conductive or insulative in nature. For example, the core material may be formed from carbon, glass, or a polymer. One example of such a fiber is nickel-coated carbon fibers.

### Lubricant

In one aspect, a lubricant can be present in the thermoplastic polymer composition. Any suitable lubricant can be incorporated into the thermoplastic polymer composition. In one aspect, the lubricant can comprise a partially saponified ester wax. For example, the lubricant can comprise a partially saponified ester wax of a C₂₂ to C₃₆ fatty acid. The fatty acid, for instance, can comprise a montan wax. In one aspect, the lubricant can contain 1-methyl-1,3-propanediyl esters. In another aspect, the lubricant can be a fatty acid amide, including fatty primary amides, fatty secondary amides, and the like. Other suitable lubricants include metal salts of fatty acids, such as calcium stearate, aluminum distearate, zinc stearate, magnesium stearate, and mixtures thereof.

Generally, the lubricant may be present in the thermoplastic polymer composition in an amount greater than about 0.01% by weight, such as in an amount greater than about 0.05% by weight, such as in an amount greater than about 0.08% by weight, such as in an amount greater than about 0.1% by weight, such as in an amount greater than about 0.2% by weight, such as in an amount greater than about 0.3% by weight, such as in an amount greater than about 0.4% by weight, and generally in an amount less than about 3% by weight, such as in an amount less than about 2.5% by weight, such as in an amount less than about 2% by weight, such as in an amount less than about 1.5% by weight, such as in an amount less than about 1% by weight, such as in an amount less than about 0.8% by weight, such as in an amount less than about 0.5% by weight of the thermoplastic polymer composition.

### Other Disclosures

In general, differential scanning calorimetry may be utilized to determine various properties of a thermoplastic polymer composition formed in accordance with the present disclosure.

The freezing point, which may be referred to as the crystallization peak temperature of the thermoplastic polymer composition, can be determined by differential scanning calorimetry (“DSC”) as is known in the art. The crystallization peak temperature is measured during the cooling stage of the differential scanning calorimetry process and is representative of the maximum of the exothermic peak obtained during the cooling process.

The thermoplastic polymer composition of the present disclosure can exhibit a freezing point from about 120° C. to about 200° C., including all increments of 1° C. therebetween, as determined by differential scanning calorimetry, such as about 120° C. or more, such as about 125° C. or more, such as about 130° C. or more, such as about 135° C. or more, such as about 140° C. or more, such as about 145° C. or more, such as about 150° C. or more, such as about 155° C. or more, such as about 160° C. or more, such as about 165° C. or more, such as about 170° C. or more, such as about 175° C. or more, such as about 180° C. or more, such as about 185° C. or more, such as about 190° C. or more, such as about 195° C. or more, such as about 200° C. or less, such as about 195° C. or less, such as about 190° C. or less, such as about 185° C. or less, such as about 180° C. or less, such as about 175° C. or less, such as about 170° C. or less, such as about 165° C. or less, such as about 160° C. or less, such as about 155° C. or less, such as about 150° C. or less, such as about 145° C. or less, such as about 140° C. or less, such as about 135° C. or less, such as about 130° C. or less, such as about 125° C. or less. The freezing point may be determined in accordance with ASTM D3418:2015.

The melting point, which may be referred to as the melting peak temperature, can be determined by differential scanning calorimetry (“DSC”) as is known in the art. The melting peak temperature is measured during the second heating stage of the differential scanning calorimetry process and is representative of the maximum of the endothermic peak during the second heating stage of the DSC process.

The thermoplastic polymer composition of the present disclosure can exhibit at least one melting point from about 175° C. to about 250° C., including all increments of 1° C. therebetween, as determined by differential scanning calorimetry, such as about 175° C. or more, such as about 180° C. or more, such as about 190° C. or more, such as about 200° C. or more, such as about 210° C. or more, such as about 215° C. or more, such as about 220° C. or more, such as about 225° C. or more, such as about 230° C. or more, such as about 240° C. or more, such as about 250° C. or less, such as about 240° C. or less, such as about 230° C. or less, such as about 225° C. or less, such as about 220° C. or less, such as about 215° C. or less, such as about 210° C. or less, such as about 200° C. or less, such as about 190° C. or less, such as about 180° C. or less. The melting point may be determined in accordance with ASTM D3418:2015.

The heat of fusion of the thermoplastic polymer composition can additionally be determined by differential scanning calorimetry. As used herein, the heat of fusion refers to the heat of fusion for the second heating stage of the DSC process. The thermoplastic polymer composition of the present disclosure can exhibit a heat of fusion of about 10 J/g to about 60 J/g, including all increments of 1 J/g therebetween. For instance, the thermoplastic polymer composition can exhibit a heat of fusion of about 10 J/g or more, such as about 15 J/g or more, such as about 20 J/g or more, such as about 25 J/g or more, such as about 30 J/g or more, such as about 35 J/g or more, such as about 40 J/g or more, such as about 45 J/g or more, such as about 50 J/g or more, such as about 55 J/g or more, such as about 60 J/g or less, such as about 55 J/g or less, such as about 50 J/g or less, such as about 45 J/g or less, such as about 40 J/g or less, such as about 35 J/g or less, such as about 30 J/g or less, such as about 25 J/g or less, such as about 20 J/g or less, such as about 15 J/g or less. The heat of fusion may be determined in accordance with ASTM D3418:2015.

In some aspects, a thermoplastic polyamide composition formed in accordance with the present disclosure may have a melt viscosity from about 500 Pa·s to about 15,000 Pa·s, including all increments of 1 Pa·s therebetween. In general, the melt viscosity may be determined in accordance with ASTM D3835 at 250° C. or 260° C. and at a shear rate of 10 s-1, 30 s-1, 100 s-1, 300 s-1, 500 s-1, 1000 s-1, 2000 s-1, or 3000 s-1 using a capillary rheometer (Kayeness). For instance, a thermoplastic polyamide composition formed in accordance with the present disclosure may have a melt viscosity of from about 500 Pa·s to about 1500 Pa·s as determined in accordance with ASTM D3835 at a temperature of 250° C. and at a shear rate of 1000 s-1. Further, for instance, a thermoplastic polyamide composition formed in accordance with the present disclosure may have a melt viscosity of from about 5000 Pa·s to about 10000 Pa·s as determined in accordance with ASTM D3835 at a temperature of 250° C. and at a shear rate of 30 s-1.

In some aspects, a thermoplastic polyamide composition formed in accordance with the present disclosure may have a charpy impact strength (e.g., notched charpy impact strength) from about 5 KJ/m² to about 30 KJ/m², including all increments of 1 KJ/m² therebetween. In general, the charpy impact strength may be determined in accordance with ISO 179-1:2023 at a temperature of −30° C., −40° C., −50° C., or −60° C. For instance, a thermoplastic polyamide composition formed in accordance with the present disclosure may have a charpy impact strength of from about 5 KJ/m² to about 25 KJ/m² as determined in accordance with ISO 179-1:2023 at a temperature of −50° C.

### EXAMPLES

### Test Methods

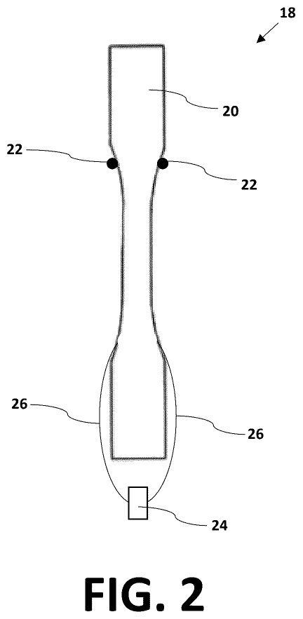

Sag Resistance Test: A sag resistance test was conducted in accordance with the following description to determine the sag stress supported by various thermoplastic polymer compositions. The thermoplastic polymer composition formulations listed below (i.e., Samples 1-5 and comparative samples C1-C7) were compounded in a 25 mm twin screw extruder or acquired as commercial products. The thermoplastic polymer compositions were molded into ASTM D638 Type IV tensile bars. As illustrated in FIG. 2, the tensile bars 20 of the sag resistance test system 18 were vertically suspended by two suspension bars 22 at the upper end of the narrow gauge section in an oven preheated to three different blow molding process temperatures. A weight 24 weighing 10 grams was suspended by cords 26 off the lower end of the narrow gauge section of the tensile bar. This put the gauge section of the tensile bar under tensile load while being heated above its melting point to an anticipated processing temperature. This setup was used to simulate a blow molding scenario where a parison of molten thermoplastic polymer composition is made to hang under its own weight from a die head. By attaching a thermocouple to the tensile bar surface and measuring its temperature rise with time after positioning inside the preheated oven, it was determined that it took 6 minutes for the tensile bar to heat up to the oven temperature. Starting with an initial suspended weight of 10 grams, an additional 3 minutes were allowed to elapse beyond the 6 minute heat-up time. In this respect, the weight was suspended from each tensile bar for a total of 9 minutes. When a tensile bar was able to support the suspended weight for the total duration without collapsing due to melt sag and drawdown, a next test was carried out with a new bar of that composition increasing the suspended weight in increments of 5 grams up to 30 grams. The test was done at three oven temperatures of 235° C., 240° C., and 250° C. to determine the highest weight that a bar of each composition could support at each temperature. The total weight was divided by the cross-sectional area of the gauge section to determine the sag stress in gm/cm² supported by the tensile bar.

Heat of Fusion Test: The heat of fusion may be determined by differential scanning calorimetry (“DSC”) as is known in the art. The heat of fusion is the differential scanning calorimetry (DSC) heat of fusion as determined by ASTM D3418:2015 for the second heating stage. Under the DSC procedure, samples were heated and cooled at 10° C. per minute as stated in ASTM D3418:2015 using DSC measurements conducted on a TA Q2000 Instrument.

Melting Point Test: The melting point is determined by differential scanning calorimetry (“DSC”) as is known in the art. The melting point is the differential scanning calorimetry (DSC) melting peak temperature as determined by ASTM D3418:2015. Under the DSC procedure, samples were heated and cooled at 10° C. per minute as stated in ASTM D3418:2015 using DSC measurements conducted on a TA Q2000 Instrument.

Freezing Point Test: The freezing point is determined by differential scanning calorimetry (“DSC”) as is known in the art. The freezing point is the differential scanning calorimetry (DSC) crystallization peak temperature as determined by ASTM D3418:2015. Under the DSC procedure, samples were heated and cooled at 10° C. per minute as stated in ASTM D3418:2015 using DSC measurements conducted on a TA Q2000 Instrument.

Parison Drop Test: A parison drop test was conducted using a Mono-ST brand blow molding machine with a 65 mm extruder screw and 890 cm³ accumulator head to measure melt sag resistance of a thermoplastic polymer composition under conditions resembling parison suspension in an actual blow molding operation. The machine has an extruder to melt and create a pool of thermoplastic material that is transferred using a transfer line to the accumulator. A die set 16 mm outer diameter is attached to the bottom of the accumulator. The melt is expulsed as a cylindrical parison vertically downwards at a controlled fixed speed by the action of a piston acting on the melt pool in the accumulator, and is suspended from the die. A series of 10 infra-red light sources and receiver pairs are positioned under the die along the travel of the parison. The first pair is located 2.5 cm (“Sensor 1”) from the die exit. Subsequent pairs are located at distances of 3 cm (“Sensor 2”), 7 cm (“Sensor 3”), 12 cm (“Sensor 4”), 22 cm (“Sensor 5”), 32 cm (“Sensor 6”), 42 cm (“Sensor 7”), 57 cm (“Sensor 8”), 82 cm (“Sensor 9”), and 110 cm (“Sensor 10”) from the first pair. The sensors are connected to a data-acquisition system. When the extrudate passes by a light source, it blocks the beam path. The corresponding receiver senses this beam blockage, and records the time for cut off. In this way, a profile of time vs. traveled distance for the leading end of the parison is recorded. The travel for an actual parison is affected by the rate of expulsion, die swell, and melt sagging. Die swell refers to the increase in the diameter of the parison in comparison to the diameter of the die geometry due to the release of stresses imposed on the melt. By comparing the measured profile against a theoretical one based only on the rate of extrusion, which has no sag and no swell, one can get a measure of the degree of sagging exhibited by the melt. Profiles of multiple materials can also be compared to rank order their respective sag resistance. Tests were conducted with the following process conditions: The extruder barrel had seven heating zones, and the temperature profile was 54° C. at the feed zone to 245° C. at zone 2 and then reducing to 235° C. towards the end of the extruder. The transfer line and accumulator were set at 235° C. The extruder screw RPM was 50. The actual melt temperature was 247° C. The piston speed during expulsion was set at 2 mm/s resulting in the parison expulsion speed at the die exit of nominally 2 cm/s.

### Example 1

Thermoplastic polymer compositions (i.e., Samples 1-5) comprising three polyamides were formed and tested for their respective sag resistance. Table 2 displays the weight percentage of the respective polyamides and the impact modifier in each respective sample. Each sample of Table 2 comprised an impact modifier. The impact modifier was a maleic anhydride grafted ethylene copolymer. Each sample of Table 2 comprised 0.5 wt. % of a hindered phenolic antioxidant, 0.5 wt. % of a secondary amine, 2 wt. % of black masterbatch, and 0.1 wt. % of aluminum distearate. As used herein, “black masterbatch” refers to 45 wt. % carbon black in an ethylene/methacrylate copolymer carrier. The sag stress supported by the respective samples at 235° C., 240° C., and 250° C. is displayed in Table 3. The sag stress supported was determined in accordance with the previously disclosed sag resistance test. Notably, the sag resistance test was not carried out for Samples 2 and 3 at 240° C. The freezing point, melting point, and heat of fusion were determined in accordance with the previously disclosed freezing point test, melting point test, and heat of fusion test. The freezing point, melting point, and heat of fusion are displayed in Table 4.

TABLE 2

| | | | | Impact |
|---|---|---|---|---|
| | PA 6 | PA 610/6T | PA 610 | Modifier |
| Sample No. | [wt. %] | [wt. %] | [wt. %] | [wt. %] |
| 1 | 30.1 | 22.1 | 14.7 | 30 |
| 2 | 29.7 | 21.8 | 14.5 | 30 |
| 3 | 34.9 | 20 | 12 | 30 |
| 4 | 41.4 | 15 | 10.5 | 30 |
| 5 | 46.9 | 7.5 | 12.5 | 30 |

TABLE 3

| | Sag Stress Supported | | | Average Sag |
|---|---|---|---|---|
| | [grams/cm²] | | | Stress Supported |
| Sample No. | 235° C. | 240° C. | 250° C. | [grams/cm²] |
| 1 | 179 | 152 | 100 | 144 |
| 2 | 152 | — | 126 | 139 |
| 3 | 152 | — | 126 | 139 |
| 4 | 152 | 126 | 100 | 126 |
| 5 | 152 | 126 | 74 | 117 |

TABLE 4

| | Freezing | Melting | Heat of |
|---|---|---|---|
| | Point | Point | Fusion |
| Sample No. | [° C.] | [° C.] | [J/g] |
| 1 | 184.4 | 221.2 | 31 |
| 2 | 186.9 | 220.6 | 41 |
| 3 | 184.7 | 219.1 | 25.9 |
| 4 | 185.6 | 220.5 | 23.7 |
| 5 | 186.8 | 220.4 | 23.7 |

Comparative compositions, one composition having three polyamides (i.e., C1) and the remaining compositions having two polyamides or one polyamide, were formed and tested for their respective sag resistance. Table 5 displays the weight percentage of the respective polyamides and the impact modifier in each respective sample. The impact modifier of Samples C1-C4 was a maleic anhydride grafted ethylene copolymer. The impact modifiers of Sample C5 were a maleic anhydride grafted ethylene copolymer in an amount of 15 wt. % and a maleic anhydride modified EPDM in an amount of 7 wt. %. The impact modifier of Samples C6-C7 was a maleic anhydride modified EPDM. Sample C1 further comprised 0.5 wt. % of a hindered phenolic antioxidant, 0.5 wt. % of a secondary amine, 2 wt. % of black masterbatch, and 0.1 wt. % of aluminum distearate. Samples C2-C6 further comprised 0.5 wt. % of a hindered phenolic antioxidant, 0.5 wt. % of a secondary amine, 2 wt. % of black masterbatch, and 0.1 wt. % of aluminum distearate. Sample C7 further comprised 0.75 wt. % of a first hindered phenolic antioxidant, 0.3 wt. % of a copper iodide/aluminum iodide stabilizer, 0.25 wt. % of a second hindered phenolic antioxidant, and 1.2 wt. % of black masterbatch. The sag stress supported by the respective comparative samples at 235° C., 240° C., and 250° C. is displayed in Table 6. The sag stress supported was determined in accordance with the previously disclosed sag resistance test. The freezing point, melting point, and heat of fusion were determined in accordance with the previously disclosed freezing point test, melting point test, and heat of fusion test. The freezing point, melting point, and heat of fusion are displayed in Table 7. Notably, the freezing point, melting point, and heat of fusion were not determined for C7.

TABLE 5

| | | | | Impact |
|---|---|---|---|---|
| | PA 6 | PA 610/6T | PA 610 | Modifier |
| Sample No. | [wt. %] | [wt. %] | [wt. %] | [wt. %] |
| C1 | 29.7 | 14.5 | 21.8 | 30 |
| C2 | — | 40.1 | 26.8 | 30 |
| C3 | 45.9 | 21 | — | 30 |
| C4 | 39.4 | 27.5 | — | 30 |
| C5 | 52.4 | 22.5 | — | 22 |
| C6 | 57.3 | 24.6 | — | 15 |
| C7 | 84 | — | — | 13.5 |

TABLE 6

| | Sag Stress Supported | | | Average Sag |
|---|---|---|---|---|
| | [grams/cm²] | | | Stress Supported |
| Sample No. | 235° C. | 240° C. | 250° C. | [grams/cm²] |
| C1 | 126 | 74 | 74 | 91 |
| C2 | 126 | 74 | 74 | 91 |
| C3 | 74 | 100 | 74 | 82 |
| C4 | 74 | 74 | 74 | 74 |
| C5 | 100 | 74 | 74 | 82 |
| C6 | 0 | 0 | 0 | 0 |
| C7 | 0 | 0 | 0 | 0 |

TABLE 7

| | Freezing | Melting | |
|---|---|---|---|
| | Point | Point | Heat of Fusion |
| Sample No. | [° C.] | [° C.] | [J/g] |
| C1 | 186.6 | 220.5 | 42 |
| C2 | 185.6 | 219.9 | 44 |
| C3 | 185.4 | 221.0 | 14.9 |
| C4 | 183.3 | 221.5 | 5.5 |
| C5 | 185.3 | 221.1 | 18.9 |
| C6 | 185.3 | 220.2 | 23.5 |
| C7 | — | — | — |

### Example 2

A thermoplastic polymer composition and two comparative compositions were formed and tested for their H₂ permeation. Table 8 displays the weight percentage of the respective polyamides and the impact modifier in each respective sample and further displays the H₂ permeability of each sample. The measured permeation values were tested in accordance with ISO 15105-1:2007. The sample size was 100 mm×100 mm×1 mm. The conditions were 25° C. and 42% RH. The impact modifier of Sample 6 is a maleic anhydride grafted ethylene copolymer. Sample 6 further comprised 0.7 wt. % of a hindered phenolic antioxidant, 0.5 wt. % of a secondary amine, 2 wt. % of black masterbatch, and 0.1 wt. % of aluminum distearate. Sample C7 is identical to Sample C7 as previously disclosed herein. The impact modifier of comparative composition C8 is a maleic anhydride modified EPDM. Comparative composition C8 further comprised 0.6 wt. % of a mixture of a hindered phenolic antioxidant and an organo-phosphite and 1 wt. % of glycol stearate.

TABLE 8

| | | | | Impact | H₂ Permeability |
|---|---|---|---|---|---|
| Sample | PA 6 | PA 610/6T | PA 610 | Modifier | [mol · m/m² · |
| No. | [wt. %] | [wt. %] | [wt. %] | [wt. %] | Pa · sec] |
| 6 | 42.1 | 16.3 | 11.8 | 26.5 | 0.27 × 10⁻¹⁶ |
| C7 | 84 | — | — | 13.5 | 0.994 × 10⁻¹⁶ |
| C8 | 78.4 | — | — | 20 | 1.54 × 10⁻¹⁶ |

### Example 3

A thermoplastic polymer composition (i.e., Sample 6) and two comparative compositions (i.e., Samples C1 and C7) as previously disclosed herein were tested for their melt viscosity characteristics. The melt viscosity (Pa·s) was determined in accordance with ASTM D3835 at 250° C. or 260° C. and at a shear rate of 10 s-1, 30 s-1, 100 s-1, 300 s-1, 500 s-1, 1000 s-1, 2000 s-1, or 3000 s-1 using a capillary rheometer (Kayeness).

TABLE 9

| | Sample 6 | Sample C1 | Sample C7 |
|---|---|---|---|
| | Melt | Melt | Melt |
| | Viscosity | Viscosity | Viscosity |
| Shear Rate | at 250° C. | at 250° C. | at 260° C. |
| [s⁻¹] | [Pa · s] | [Pa · s] | [Pa · s] |
| 3000 | — | — | 293 |
| 2000 | — | — | 362 |
| 1000 | 889 | 289 | 551 |
| 500 | — | — | 844 |
| 300 | 1904 | 584 | — |
| 100 | 3892 | 1003 | 1900 |
| 30 | 7200 | 1807 | — |
| 10 | 11585 | 3111 | — |

### Example 4

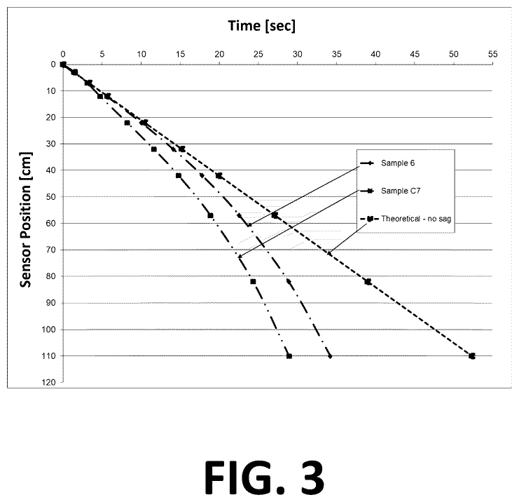

A thermoplastic polymer composition (i.e., Sample 6) and comparative composition (i.e., Sample C7) as previously disclosed herein were subjected to the parison drop test as previously disclosed herein. The parison end distance travel vs. time profiles for the two compositions as well as a theoretical profile with no sag are shown numerically in Table 10 and illustratively in FIG. 3.

TABLE 10

| | | | Time to Reach |
|---|---|---|---|
| | Time to Reach | Time to Reach | Sensor |
| | Sensor (s) | Sensor | [s] |
| | [s] | [s] | Theoretical |
| Sensor | Sample 6 | Sample C7 | Sample |
| 1 | 0 | 0 | 0 |
| 2 | 1.31 | 1.55 | 1.43 |
| 3 | 3.28 | 3.12 | 3.33 |
| 4 | 5.59 | 4.75 | 5.71 |
| 5 | 10.03 | 8.22 | 10.46 |
| 6 | 14.11 | 11.64 | 15.22 |
| 7 | 17.81 | 14.80 | 19.97 |
| 8 | 22.56 | 18.87 | 27.10 |
| 9 | 28.88 | 24.34 | 38.99 |
| 10 | 34.20 | 28.93 | 52.31 |

As observed in Table 10 and as illustrated in FIG. 3, Sample 6 has substantially better sag resistance than Sample C7.

### Example 5

A thermoplastic polymer composition (i.e., Sample 6) and comparative composition (i.e., Sample C7) as previously disclosed herein were injection molded to form test bars for charpy impact testing per test method ISO 179-1:2023. The test bars were notched and either tested in an as-molded state or conditioned to constant weight at 63% RH and 70° C., and then tested at various temperatures from 23° C. to −60° C. The results are shown in Table 11. The “−” in Table 11 are indicative that the respective sample was not tested at the respective temperature.

TABLE 11

| | Sample 6 | Sample 6 | Sample C7 | Sample C7 |
|---|---|---|---|---|
| Test | (As-molded) | (Conditioned) | (As-molded) | (Conditioned) |
| Temper- | Notched | Notched | Notched | Notched |
| ature | charpy | charpy | charpy | charpy |
| [° C.] | [kJ/m²] | [kJ/m²] | [kJ/m²] | [kJ/m²] |
| 23 | 80 | 72 | 80 | 150 |
| −30 | 24 | 26 | 22 | 21 |
| −40 | — | — | 15 | 14 |
| −50 | 17 | 18 | — | — |
| −60 | 13 | 15 | — | — |

As observed in Table 11, Sample 6 shows better impact toughness at colder temperatures than Sample C7. Notably, hydrogen tank liners may be exposed to cold temperatures during fast fill-discharge cycles. In this respect, high impact toughness at cold temperatures is generally advantageous.

While particular embodiments of the present disclosure have been illustrated and described, it would be obvious to those skilled in the art that various other changes and modifications can be made without departing from the spirit and scope of the present disclosure. It is therefore intended to cover in the appended claims all such changes and modifications that are within the scope of this disclosure.

What is claimed:

1. A thermoplastic polymer composition comprising:
a first polyamide, the first polyamide comprising a first aliphatic homopolyamide;
a second polyamide, the second polyamide comprising a semi-aromatic copolyamide;
a third polyamide, the third polyamide comprising a second aliphatic homopolyamide, wherein the first aliphatic homopolyamide and the second aliphatic homopolyamide are present in the thermoplastic polymer composition in a weight ratio of about 5:4 or more; and
an impact modifier, the impact modifier being present in the thermoplastic polymer composition in an amount greater than about 5 wt. %.

2. The thermoplastic polymer composition of claim 1, wherein the first aliphatic homopolyamide comprises repeat units derived from a lactam having 6 to 20 carbon atoms.

3. The thermoplastic polymer composition of claim 1, wherein the second aliphatic homopolyamide comprises repeat units derived from an aliphatic dicarboxylic acid having 6 to 20 carbon atoms and an aliphatic diamine having 4 to 20 carbon atoms.

4. The thermoplastic polymer composition of claim 1, wherein the semi-aromatic copolyamide comprises repeat units derived from an aromatic dicarboxylic acid having 8 to 20 carbon atoms and an aliphatic diamine having 4 to 20 carbon atoms.

5. The thermoplastic polymer composition of claim 4, wherein the semi-aromatic copolyamide further comprises repeat units derived from an aliphatic dicarboxylic acid having 6 to 20 carbon atoms and an aliphatic diamine having 4 to 20 carbon atoms.

6. The thermoplastic polymer composition of claim 1, wherein the semi-aromatic copolyamide comprises a first repeat unit present in an amount from about 50 mole percent to about 90 mole percent and a second repeat unit present in an amount from about 10 mole percent to about 50 mole percent of the semi-aromatic copolyamide.

7. The thermoplastic polymer composition of claim 6, wherein the first repeat unit is an aliphatic repeat unit and the second repeat unit is an aromatic repeat unit.

8. The thermoplastic polymer composition of claim 1, wherein the semi-aromatic copolyamide comprises a first repeat unit present in an amount from about 60 mole percent to about 80 mole percent and a second repeat unit present in an amount from about 20 mole percent to about 40 mole percent of the semi-aromatic copolyamide.

9. The thermoplastic polymer composition of claim 8, wherein the first repeat unit is an aliphatic repeat unit and the second repeat unit is an aromatic repeat unit.

10. The thermoplastic polymer composition of claim 1, wherein the first aliphatic homopolyamide and the second aliphatic homopolyamide are present in the thermoplastic polymer composition in a weight ratio of about 3:2 or more.

11. The thermoplastic polymer composition of claim 1, wherein the impact modifier is functionalized.

12. The thermoplastic polymer composition of claim 1, wherein the impact modifier comprises an anhydride group.

13. The thermoplastic polymer composition of claim 1, wherein the first aliphatic homopolyamide is present in the thermoplastic polymer composition in an amount from about 20 wt. % to about 70 wt. %.

14. The thermoplastic polymer composition of claim 1, wherein the second aliphatic homopolyamide is present in the thermoplastic polymer composition in an amount from about 2 wt. % to about 20 wt. %.

15. The thermoplastic polymer composition of claim 1, wherein the semi-aromatic copolyamide is present in the thermoplastic polymer composition in an amount from about 2 wt. % to about 30 wt. %.

16. The thermoplastic polymer composition of claim 1, wherein the impact modifier is present in the thermoplastic polymer composition in an amount less than about 50 wt. %.

17. The thermoplastic polymer composition of claim 1, wherein the semi-aromatic copolyamide and the second aliphatic homopolyamide comprise repeat units derived from the same diacid and the same diamine.

18. The thermoplastic polymer composition of claim 1, wherein the semi-aromatic copolyamide comprises aliphatic repeat units, wherein the second aliphatic homopolyamide comprises aliphatic repeat units, wherein the aliphatic repeat units of the semi-aromatic copolyamide and the aliphatic repeat units of the second aliphatic homopolyamide are derived from the same diacid and the same diamine.

19. The thermoplastic polymer composition of claim 1, wherein the first aliphatic homopolyamide is PA 6, wherein the semi-aromatic copolyamide is PA 610/6T, and wherein the second aliphatic homopolyamide is PA 610.

20. The thermoplastic polymer composition of claim 19, wherein the first aliphatic homopolyamide is present in the thermoplastic polymer composition in an amount from about 30 wt. % to about 60 wt. %, wherein the semi-aromatic copolyamide is present in the thermoplastic polymer composition in an amount from about 5 wt. % to about 25 wt. %, the semi-aromatic copolyamide comprising an aliphatic repeat unit present in an amount from about 60 mole percent to about 90 mole percent and an aromatic repeat unit present in an amount from about 10 mole percent to about 40 mole percent of the semi-aromatic copolyamide, wherein the second aliphatic homopolyamide is present in the thermoplastic polymer composition in an amount from about 5 wt. % to about 15 wt. %, and wherein the impact modifier is present in the thermoplastic polymer composition in an amount from about 15 wt. % to about 40 wt. %.

21. A thermoplastic polymer composition comprising:
a first polyamide, the first polyamide comprising an aliphatic copolyamide;
a second polyamide, the second polyamide comprising a semi-aromatic copolyamide;
a third polyamide, the third polyamide comprising an aliphatic homopolyamide, wherein the aliphatic copolyamide and the semi-aromatic copolyamide are present in the thermoplastic polymer composition in a weight ratio of about 6:5 or more; and
an impact modifier, the impact modifier being present in the thermoplastic polymer composition in an amount greater than about 5 wt. %.

22. The thermoplastic polymer composition of claim 21, wherein the aliphatic copolyamide comprises repeat units derived from an aliphatic dicarboxylic acid having 6 to 20 carbon atoms and an aliphatic diamine having 4 to 20 carbon atoms.

23. The thermoplastic polymer composition of claim 21, wherein the aliphatic copolyamide further comprises repeat units derived from a lactam having 6 to 20 carbon atoms.

24. The thermoplastic polymer composition of claim 21, wherein the semi-aromatic copolyamide comprises repeat units derived from an aromatic dicarboxylic acid having 8 to 20 carbon atoms and an aliphatic diamine having 4 to 20 carbon atoms.

25. The thermoplastic polymer composition of claim 24, wherein the semi-aromatic copolyamide further comprises repeat units derived from an aliphatic dicarboxylic acid having 6 to 20 carbon atoms and an aliphatic diamine having 4 to 20 carbon atoms.

26. The thermoplastic polymer composition of claim 21, wherein the aliphatic homopolyamide comprises repeat units derived from an aliphatic dicarboxylic acid having 6 to 20 carbon atoms and an aliphatic diamine having 4 to 20 carbon atoms.

27. The thermoplastic polymer composition of claim 21, wherein the semi-aromatic copolyamide and the aliphatic homopolyamide comprise repeat units derived from the same diacid and the same diamine.

28. The thermoplastic polymer composition of claim 21, wherein the semi-aromatic copolyamide comprises aliphatic repeat units, wherein the aliphatic homopolyamide comprises aliphatic repeat units, wherein the aliphatic repeat units of the semi-aromatic copolyamide and the aliphatic repeat units of the aliphatic homopolyamide are derived from the same diacid and the same diamine.
